(19) United States
(12) Patent Application Publication
(10) Pub. No.: US 2011/0268162 A1
(43) Pub. Date: Nov. 3, 2011

(54) Preventing inter-set miscommunication while maintaining robust signalling in a noisy environment

(75) Inventor: Sean C. Carroll, Kelowna (CA)

(73) Assignee: Signalink Technologies Inc.

(21) Appl. No.: 13/064,996

(22) Filed: May 2, 2011

Related U.S. Application Data
(60) Provisional application No. 61/282,971, filed on Apr. 30, 2010.

(51) Int. Cl. H04B 1/38

(52) U.S. Cl. 375/219

(57) ABSTRACT

A method and apparatus for preventing inter-set miscommunication while maintaining robust signalling in a noisy environment includes providing a controller and a set of devices, the set of devices having a unique set ID and communicating with said controller. The set of devices communicates with said controller by transmitting and receiving messages to and from the controller respectively via an electrically noisy transmission medium. The messages include: (a) inquiries from the controller to the set of devices inquiring as to whether each device either doesn't need attention or does need attention from the controller; and, (b) responses to the controller from each device as to whether each device needs attention or doesn't need the attention of controller. Each device transmits its own responses, once and in a “look-back” embodiment repeatedly receives the responses of other devices and stores those responses of the other devices in a look-back record in its message. The attention segment of the messages includes the doesn't-need-attention or does-need-attention-of-the-controller for each device and for those devices transmitting before each particular device and received by that device. The device ID has been incorporated into the error check segment. Each device is adapted to, using the set ID, make the error check segment set ID dependant.

### CROSS REFERENCE TO RELATED APPLICATION

This application claims priority from U.S. Provisional Patent Application No. 61/282,971 filed Apr. 30, 2010 entitled Methods and Apparatus for Improved Communications in a Noisy Environment.

### FIELD OF THE INVENTION

This invention relates to the field of communication between devices in a electrically noisy transmission medium and in particular to a method and apparatus for preventing inter-set miscommunication while maintaining robust signalling in a noisy environment.

### BACKGROUND OF THE INVENTION

As discussed in U.S. Pat. No. 7,852,745 the problem of inter-device interference due to the non-linear nature of a transmission medium needs to be overcome when multiple devices are sharing the transmission medium. Although the devices may be part of the same set of devices they could be parts of different sets of devices as well. When the different sets of devices are transmitting using different frequencies the modulation products from one set of devices becomes noise to other set of devices sharing a non-linear transmission medium. However, the different sets of devices could have transmission frequencies in common. This poses a problem if the sets of devices are not well separated by attenuation, in particular if a message from a device in one set of devices is received by a device or devices in another set and is accepted as a valid in-set message thus causing inter-set miscommunication. This inter-set miscommunication must be eliminated for the sets of devices to perform reliably. Other forms of noise can contribute to making communication between devices difficult.

### SUMMARY OF THE INVENTION

In summary, the method and apparatus for preventing inter-set miscommunication while maintaining robust signalling in a noisy environment may be characterized in one or more aspects including a controller and a set of devices, and providing same, the set having a unique set ID and communicating with said controller. The set of devices communicates with said controller by transmitting and receiving messages to and from the controller respectively via an electrically noisy transmission medium. The messages include: (a) inquiries from the controller to the set of devices inquiring as to whether each device either doesn't need attention or does need attention from the controller; and, (b) responses to the controller from each device as to whether each device needs attention or doesn't need the attention of controller.

Each device has a unique device ID which is unique within the set of devices. The devices each include a transmitter/receiver, and include a processor, and associated memory cooperating with the transmitter/receiver, to transmit and receive the messages. Each device transmits its own said responses, once only in response to an inquiry from the controller, and in a “look-back” embodiment repeatedly receives the responses of other devices and stores those responses of the other devices in a look-back record in its message. The device then transmits the message.

Each message consists of: a preamble segment, a doesn't need attention or does need attention segment and an error check segment. Preferably these segments occur in that order. The attention segment contains the doesn't-need-attention or does-need-attention of the controller for each device and in the “look-back” embodiment, for those devices transmitting before each particular device and received by that device, and wherein the device ID has been incorporated into the error check segment, and wherein each device is adapted to, using said set ID, make the error check segment set ID dependant as better described below.

The attention segment may contain the needs-attention or the doesn't-need attention of the controller for each device and in the “look back” embodiment for a sequentially previously transmitted series of the responses of the other devices which have sequentially previously transmitted immediately before transmission of the response by each particular device. The series is limited in length by a length of the attention segment.

The controller is adapted to listen for each device during an associated series of time-slots and thereby determines a device ID of an incoming response by matching a corresponding time-slot with a corresponding expected device ID. The controller adds the expected device ID to the attention segment and adds the set ID to said attention segment and compares a resulting segment with the error check segment. The controller extracts from the attention segment the needs-attention or doesn't-need attention of all corresponding devices and to transmit a further query to those devices identified as having a do-need-attention status. In the “look back” embodiment the look back record may be a bit string indicating, for a corresponding device in the record, a binary don't need/need attention record.

The set may have a set ID associated therewith which includes the unique identifying number of the controller. Each device ID unique to the set which is shorter than a corresponding unique identifying number of each the device.

Each message may be transmitted using a seed to generate a seed-specific error check procedure which generates a specific error check. Each message may also contain a pattern seed. Each message may further include corresponding pattern length information and a corresponding pattern count incrementing for a transmission window. The length information dictates a corresponding length of a corresponding pattern.

Where the transmission medium is an alternating current power line and therefore said noise is cyclical, each controller and the devices may be adapted to: (a) provide an array of reception channels collectively spanning a length of one cycle of an alternating current waveform in the alternating current power line and corresponding cyclical noise; and (b) receiving the message within a less noisy segment using a corresponding channel. What each channel receives is treated as a potential message and is checked by the error check segment in an error check.

The method for preventing inter-set miscommunication while maintaining robust signalling in a noisy environment may be further characterized as including in one embodiment:
a) providing a set of devices, each device of the set of devices having a receiver and transmitter cooperating with a processor and memory in each device,
b) providing a controller with a corresponding receiver and transmitter cooperating with a corresponding controller processor and controller memory in the controller,
c) transmitting and repeating a first message to each device from the controller asking each device if each device needs attention from the controller or does not need attention from the controller,
d) each device transmitting in response a don't need-attention/need attention message corresponding to whether each device needs the attention or not of the controller,
e) in a “look back” embodiment each device maintaining a look-back record of the response of any of each the devices previously transmitting a corresponding response corresponding to the first message,
f) each device composing said response, including if applicable the look-back record, and transmitting the response to the controller, wherein the controller records the responses from each device according to a response received directly from each particular device, and in the “look-back” embodiment, the response for a particular device from the look-back record from any response from any of the other devices,

Each of the responses are messages which consist of a preamble, a don't-need-attention/need-attention for a corresponding device, the look-back record in the “look back” embodiment, and an error check, and wherein the device ID has been incorporated into each error check for a corresponding device, unique within the set, and, using a unique set ID for the set, making the error check dependant on the set ID. The controller upon receiving each message within an allotted time-slot for a particular device, adds a corresponding unique device ID and the set ID to the don't-need attention/need attention and the look-back record if applicable and performs an error check comparing the error check against the don't-need attention/need attention, and the look-back record if applicable, having added the device ID and the set ID.

### BRIEF DESCRIPTION OF THE DRAWINGS

In the figures wherein like reference characters denote corresponding parts in each view:

FIG. 1 is a diagram of a device from a set of devices described herein.

FIG. 2 is a long conventional format of a message containing does-not-need/does need attention data in a string of bits.

FIG. 3a is a shortened format of the message of FIG. 2 according to one aspect of the present invention.

FIG. 3b is the format of FIG. 3a with a longer modified error check according to a further aspect of the present invention.

FIG. 3c is the format of FIG. 3b with a pattern seed, length and count inserted.

FIG. 4 is an example of a transmit, don't transmit pattern.

FIG. 5 is an example of a noisy AC signal.

FIG. 6 is a plot of the example of FIG. 5 showing the noise matched along a series of reception channels.

FIG. 7 is a plot of message bits.

FIG. 8 is a plot of the message bits of FIG. 7 added to the noise of FIG. 6.

FIG. 9 is a plot of the message bits in reception channel e in FIG. 8.

### DETAILED DESCRIPTION OF EMBODIMENTS OF THE INVENTION

An example where inter-set miscommunication could happen is two buildings that share a power transformer. Each building has a set of devices installed inside it that pass information over the power line to that building's central controller. The fact that the buildings share the same power transformer allows the set of devices in building one to potentially cause inter-set miscommunication with the other set of devices in building two and vice versa.

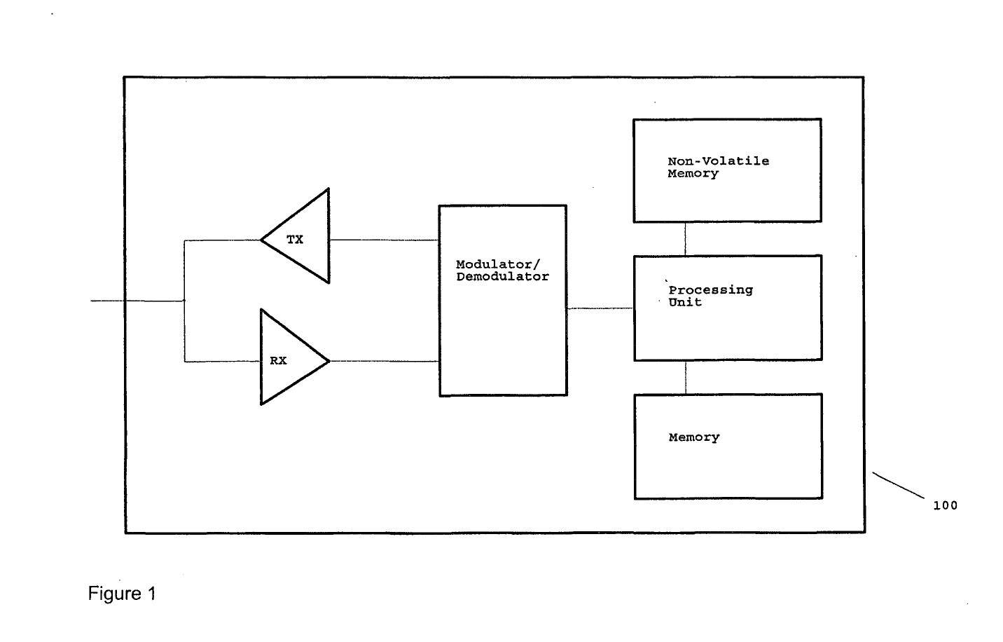

Referring to FIG. 1, each device 100, from the inventory of devices described below, has a transmit section TX, a receive section RX, and a modulator/demodulator cooperating with its processor unit and associated memory including non-volatile memory. Each device 100 operates by known means to transmit and receive messages as a sequence of bits. During manufacture each device is programmed with a unique identification number or unique ID. These numbers should be long, say 32 bits long, because each device ever made must have a unique number assigned to it. As well, the device is programmed with a default preamble and a default set identification number or default set-ID. As well, the device is programmed with a list of potential set-preambles. As well, the device is programmed with a list of error check multipliers. These are all stored in the device's non-volatile memory.

Before the installation process the devices are configured into a set of devices. This configuration consists of having the central controller programmed with the list of the unique IDs of the devices that will form the set of devices. This can be accomplished by bar code scanning where each device has its unique ID printed on a bar code label attached to it. These unique IDs are stored in the central controller's non-volatile memory. Once the devices have been installed each device is contacted by the central controller by the device's unique ID using the default preamble and default set-ID and is assigned by the central controller a device identification number or device ID and a set identification number set-ID which it stores in non-volatile memory. The device ID is unique to the set of devices and is shorter than the unique ID. The set-ID is formed from the central controller's unique ID and in the preferred case is the entire central controller's unique ID. The set-preamble is selected from the list of potential set-preambles. As mentioned above, the unique IDs must be long for so that every device produced has its own. For efficiency it is better to use the shorter device ID. The set-ID can be used to effectively to eliminate inter-set miscommunication as described below.

It is often advantageous to have the central controller know which devices in its set of devices need attention and it is often the case that this information should be updated as frequently as possible. It is possible for the central controller to request this information from each device individually but this is time consuming. In many cases the state of a device does not change significantly between requests and a device that has not had a change in state will not need the attention of the central controller. It is therefore better if the device can transmit a short message that indicates if the device needs attention or not. A method for efficiently determining if a device needs attention or does not need attention is as follows.

The central controller transmits a “needs-attention” request message simultaneously to all devices. As mentioned above each device has a device ID that is unique to its set of devices. A device that hears the message waits until a time slot that is given by its device ID and responds with a message that contains information about its need for attention and the need for attention of a number of devices that transmit before it. Herein, this is referred to as a “look back”, and the recording of the corresponding responses, is herein referred to as a look back record. This message is not re-transmitted by other devices. However, other devices that hear the device will temporarily record in memory that the device responded and whether it needs attention or not. Each device will incorporate the information from multiple devices that transmit before it into its own message.

For example, a device has device ID 52 and the set of devices is configured so that the device listens, that is looks back, for the previous 15 devices. It will set a bit in the message if the device itself does not need the attention of the central controller. As well, it will set bits in its message, that is in its look back record, indicating that it heard device 37 through device 51 and that those devices do not need the attention of the central controller if it detects their messages and if they indeed do not need the attention of the central controller. Furthermore, it will set bits in its message if it hears another device indicate that they heard a device on its list and that the device they heard does not need attention. For example, if device 52 hears device 41 indicate that they heard device 39 and that device 39 does not need attention device 52 will set the bit corresponding to device 39 in its message even if it does not hear from device 39 directly. In this way if only the message from device 52 is detected by the central controller the central controller can record which of the devices 37 though 52 needs attention. If a device, say 43, needs attention it will respond as well, but device 52 will not set the bit that corresponds to device 43 not needing attention in its message. The response from device 43 may or may not be heard by the central controller. In either case the central controller will contact device 43 separately so that the central controller can determine how the state of the device changed. A device that is not heard by the central controller and is not heard by other devices needs the attention of the central controller by default. This is the reason the bits are set if the device is heard and does not need attention. In order to be efficient these messages should be kept as short as possible.

A loose analogy of this would be a crowded noisy restaurant with a group of invited guests seated at a large table. Their anxious host (the controller in the analogy) wants to ensure that everyone is fine. The host makes a request for everyone to let him know how they are but because of the amount of noise he can't hear everyone. Here the analogy breaks down a little because each guest has a card in front of them that has the names of a few guests on it. They are to hear and remember if the guests named on their card are fine and pass this information to the host. The guests respond mostly by saying they are fine and that the others on their list are fine as well. If Cathy hears that everyone on her card is fine she will say “We are all fine”. If only Cathy is heard by the host and she says “We are all fine” the host will know that everyone on Cathy's card is fine. If Cathy hears John, who is on her card, say that he is not fine or if Cathy does not hear from or about John at all she will say “We are all fine except for John”. If no guest who has John on their card indicates that John is fine the host will know that John needs attention.

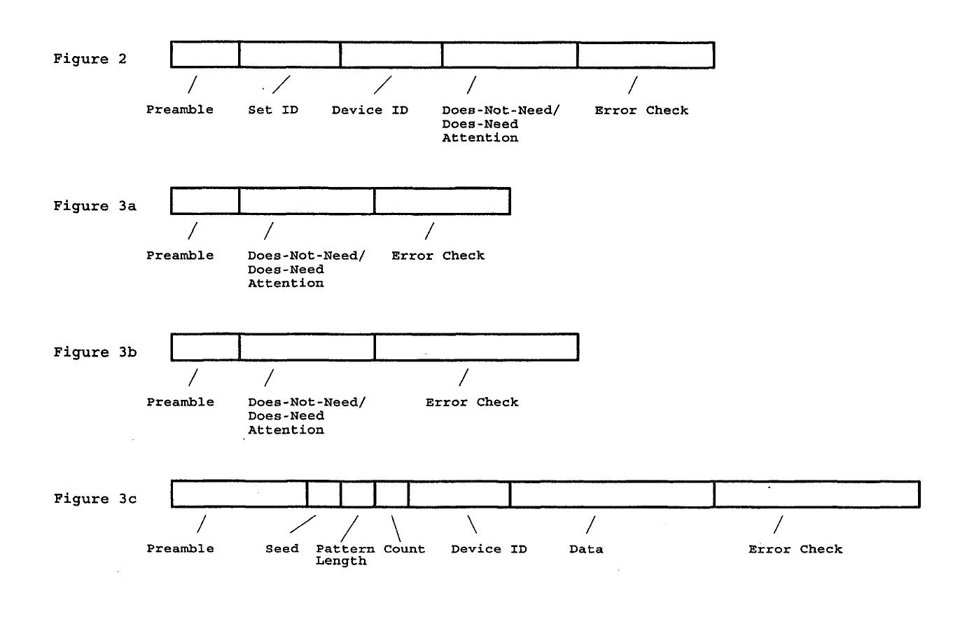

FIG. 2 shows a possible message that could be transmitted to indicate this does-not-need/does-need attention information. In this example the message contains an 8 bit preamble, a 12 bit set-ID, a 12 bit device ID, 16 bits of does-not-need/does-need attention information described above, and 16 bits of error check. Here the set-ID is not the central controller's unique ID but, for example, the last 12 bits of it. Error checking is often done by adding information to the end of a message. When the error checking procedure is performed on the contents of the message and the result agrees with the added information the message is deemed to be a valid message. A potential message with the added information not agreeing with that generated by the error checking procedure will be rejected. The preamble need not be long in this case due to the fact that the messages are expected in a short time slot and could be the last 8 bits of the longer set-preamble. This message is very inefficient. In order to transmit the 16 does-not-need/does-need attention bits the message is 64 bits long.

Often the combination of a preamble and a specific ID is treated as a longer preamble that devices use to determine the start of a message. In the case of FIG. 2 the devices would be looking for the preamble immediately followed by the set-ID to determine that a message is starting. However, this is not effective at preventing inter-set miscommunication. In an environment with changing noise and attenuation it is possible that a device will receive the preamble and the set-ID from a device in its own set of devices and then have a message from a device in another set of devices dominate the remainder of the message thus replacing the contents of the message and “hijacking” it. If the error check is performed with the same error checking procedure the hijacked message will pass the error check and be accepted as a valid message and inter-set miscommunication has occurred.

FIG. 3a shows a more efficient preferred message. This message contains an 8 bit preamble, the 16 bits of does-not-need/does-need attention information, and 16 bits of error check. The order is preferred but not intended to be limiting. Here the message is much more efficient requiring only 36 bits. In order to make this possible the device ID has been incorporated into the error check and the set-ID has been used to make the error check set-ID dependant. The message from the device occurs at a well known time so that a device listening for this message need only assume that the device whose time slot is occurring has transmitted the message. It can append the device ID to the beginning of the message and perform the error check. The device that is transmitting the message must also append the device ID to the beginning of the message before forming the error check. It does not however transmit it.

It should be noted that some of the bits that would have been used to transmit the set-ID and device ID may be used to make the error check longer as shown in FIG. 3b. Here the error check is 24 bits long and is therefore on the order of 256 times less likely to pass a bad message than a 16 bit error check.

The set-ID stored in the devices non-volatile memory may be used as a “seed” to form an error checking procedure that is different for different sets of devices. For example, an error check can be made by breaking the message into blocks of bits and treating each block of bits as a binary number. These numbers are then multiplied by a sequence of error check multipliers and the results are added together. A modulo operation is then performed to make the error check a fixed size.

The set-ID is used as the seed of, for example, a pseudorandom number generation procedure that generates a sequence of index numbers. The pseudorandom number generation procedure produces a sequence of numbers that look like random numbers but it will always produce the same sequence of numbers from the same seed. This sequence of index numbers is used to reference the list of error check multipliers that were programmed into the device as described above. This operation does not have to be performed for every message. The device can form a list of error check multipliers that is sufficiently long for the longest message expected and store these numbers in new memory locations. These error check multipliers are used in sequence by the error checking procedure. Because different set-IDs will produce different sequences of index numbers from the pseudorandom number generation procedure, different set-IDs produce a different sequence of error check multipliers that are used in the error checking procedure. Thus different set-IDs produce different error checking procedures. The error checking procedure for one set-ID is highly unlikely to produce the same error check as the error checking procedure from a different set-ID. The error checking procedures have become set-ID dependant.

The error check as shown in FIG. 3b is 24 bits long. The operations above do not have to produce a 24 bit long number but can produce for example two 12 bit numbers that are joined together for form the 24 bit error check. This has the advantage of increasing the number of multipliers used and hence increasing the number of possible permutations of multipliers that the set-ID can produce. The message shown in FIG. 3b when the 12 bit device ID is appended to the beginning of the message is 36 bits long; the error check itself is not included in this count. The message is broken into blocks of bits of fixed length, for example blocks of bits that are 8 bits long. In this case the result is four 8 bits blocks and one 4 bit block. The 4 bit block is treated as an 8 bit block and the five results are considered to be binary numbers. If we use two error checks that are 12 bits long we have 2×5 or 10 multipliers that will be used. Assuming a list of 256 different error check multipliers stored in non-volatile memory the number of possible permutations of error check multipliers is far greater than the number of possible set-IDs even if the set-IDs are the preferred 32 bit central controllers unique ID.

For example, the message when treated as 5 blocks of bits, produces the numbers 67, 247, 129, 111, 231. The set-ID for this particular set of devices when used as a seed produced the sequence of index numbers 81, 87, 236, 21, 132, 144 . . . . These index numbers referred to non-volatile memory locations where the error check multipliers 17, 23, 127, 97, 263, 157 . . . were stored. The error check procedure performs the following to generate an intermediate result: (67×17)+(247×23)+(129×127)+(111×97)+(231×263)=94,723. A modulo operation is then performed on this intermediate result. This modulo operation divides the intermediate result 94,723 by a number, for example 4093, and keeps the remainder as the error check result. This remainder must of course be smaller than 4093 so that in this case the result is always smaller than the maximum value of 12 binary bits (4095). The error check result in this case is 584. When two 12 bit error checks are used a similar operation using the next error check multipliers is performed to produce a second 12 bit error check result. The first error check result is compared to the first 12 bits of the error check that was received. The second error check result is compared to the second 12 bits of the error check that was received. If they are both the same the message is assumed to be correct.

A problem with the above is that the numbers the message produces could include a number of zeros. This is easily remedied by, for example, as is illustrated in the next sentence by adding the next error check multiplier to the number from the message before performing the multiplication. In this preferred case the error check procedure performs the following to generate an intermediate result: ((67+23)×17)+((247+127)×23)+((129+97)×127)+((111+263)×97)+((231+157)×263).

Making the error checking procedure set-ID dependant makes the set-ID effective at eliminating inter-set miscommunication. This is of importance in general but in the case of does-not-need/does-need attention messages, where devices listen during multiple time slots for multiple messages, the chance that a message from another set will be heard is increased and thus the possibility of inter-set miscommunication is likewise increased.

It should be noted that the incorporation of the device ID into the error check will continue to make the device ID effective in making sure the expected device was transmitting.

To clarify, referring back to the noisy restaurant analogy, the host makes a request to find out if everyone is fine. Cathy listens for the guests on her card. However, another table with another group of guests is seated close to Cathy. When she is listening she hears a guest from the other table who sounds just like John say that he is fine while in fact John is suffering from an allergic reaction and cannot speak. If Cathy accepts what she heard from the other table as a valid message from her John and says to the host “We are all fine” the repercussions for John could be bad. However, here the analogy breaks down even further because also listed on Cathy card is a procedure that is unique to her table. Every guest at her table has the same procedure on their card and every time one of them responds to the host's request they instantly perform the procedure that results in a five word phrase and they add this phrase to the end of what they say. Cathy instantly performs this procedure on what she heard “John” from the other table say excluding his last five words and it results in the phrase “The catfish sleeps at dawn”. Everyone at her table would agree that the correct ending should have been “The catfish sleeps at dawn”. However, because the “John” Cathy hears is at another table he has a different procedure listed on his card and he ended what he said with “Water donkeys have wet fur”. Because these phrases do not match Cathy knows not to indicate that John is fine.

Often with a set of devices that has to overcome significant noise and/or attenuation the central controller cannot be in direct contact with every device in its set. In addition, it is often the case that ability of the central controller to be in direct contact with a device changes in time. For example, in a large building, human activities can cause noise sources to come and go and the attenuation between devices to change; a device that the central controller can directly contact at one time may be out of direct contact a moment later. A method for enabling the central controller to contact each device in its set of devices without putting special emphasis on any particular device or devices is as follows.

To enable the central controller to contact each device in its set of devices messages are re-transmitted with a re-transmission pattern controlled by a pattern seed. As shown in FIG. 3c when a message is transmitted it contains pattern seed information, pattern length information, and pattern count information. For example, FIG. 3c, is the “needs attention” request message described above.

The pattern seed is something the device uses, in combination with its device ID, to form a re-transmission pattern by a mathematical operation. For example, the operation could be “take the pattern seed and multiply by your device ID and form a binary pattern corresponding to the result”. By having different pattern seeds different re-transmission patterns can be obtained from the same device ID.

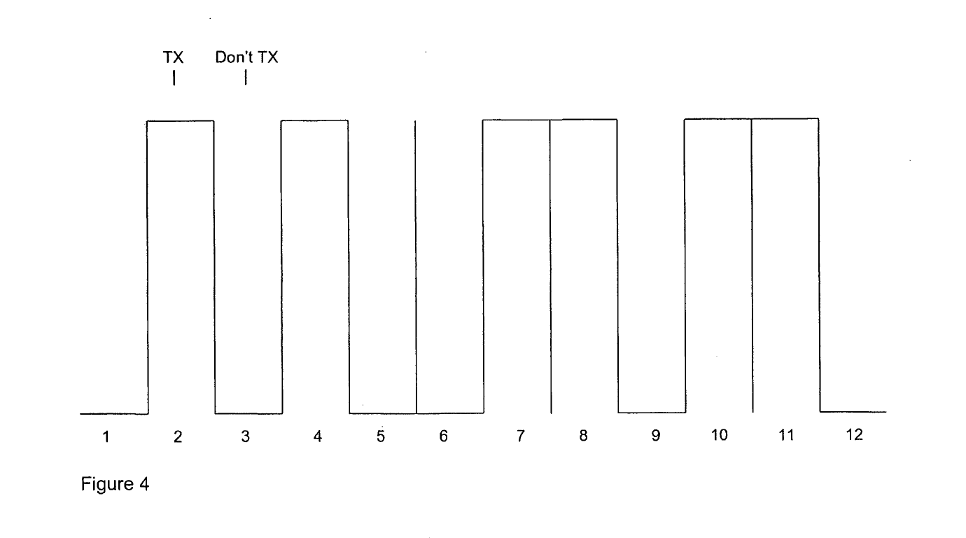

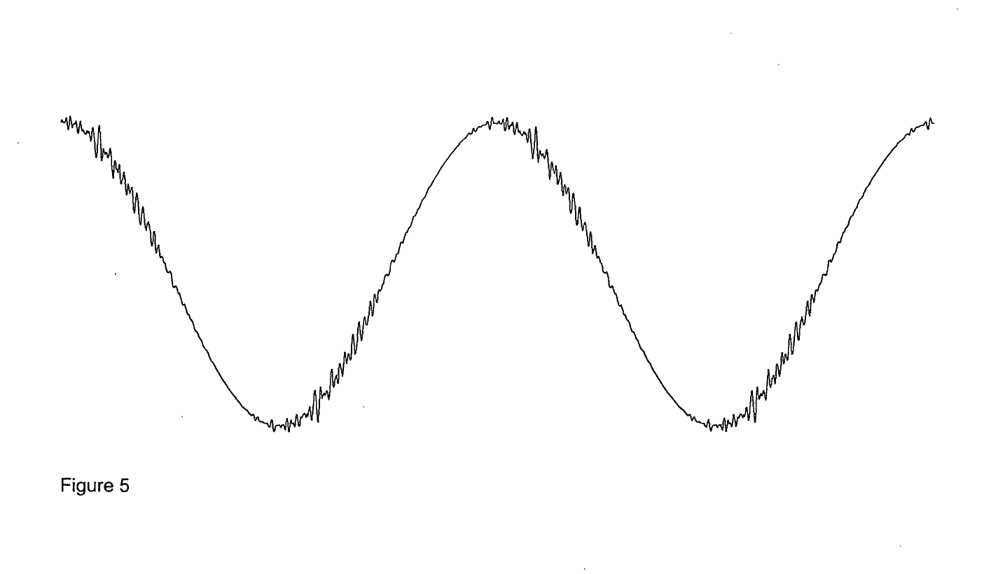

FIG. 4 shows a possible re-transmission pattern. Note that the pattern contains time slices where the device re-transmits and time slices where it does not. In the case where devices can choose between different frequencies to transmit the re-transmission pattern could indicate where the device will transmit on one set of frequencies or another.

As well as a pattern seed the message contains pattern length information which lets the devices know how much of the pattern to use and pattern count information to let the device know where in the pattern to begin re-transmission. Every time the message is re-transmitted, by any device, the pattern count number within the message is incremented. During some possible re-transmission time slots a device may not transmit but may simply wait the duration of the time slot. In this case the pattern count number will be incremented internally by the device. In this way all devices that have heard a message or a re-transmitted message agree on the pattern count whether they are transmitting or not.

For example, a message is transmitted with the information: pattern seed=12, pattern length=8, pattern count=1. The first message will have a count of one. When this message is next re-transmitted the information will be: pattern seed=12, pattern length=8, pattern count=2. This assumes at least one device had a transmit pattern that indicated it should transmit in slot 2. The next time it is re-transmitted the information will be: pattern seed=12, pattern length=8, pattern count=3 (assuming a message is transmitted in slot 3) and so on. In this example, a device hears the message at pattern count 3. It will generate a re-transmission pattern of a form similar to the one shown in FIG. 4 from its device ID and the pattern seed of 12, and will know that it should re-transmit or not re-transmit (i.e. wait) in the next time slot according to what occurs in slot 4 of the re-transmission pattern. It also knows to keep following the pattern, either re-transmitting or waiting until the pattern count reaches 8, which is indicated by the pattern length. In this case the pattern tells the device to re-transmit in time slot 4 then wait during time slot 5 and time slot 6, then re-transmit during time slot 7 and time slot 8. It will stop at 8 because the pattern length was 8. Note that the pattern continues beyond slot 8 indicating that longer pattern lengths could be used.

This method of seeded re-transmission allows messages to be passed between devices that are not in direct contact without putting special emphasis on any particular device or devices. Importantly, it also allows “deadlocks” to be broken. It is possible for two devices to generate similar re-transmission patterns given their device IDs and a particular pattern seed. In this case they will re-transmit repeatedly at approximately the same times. It is also possible that these devices will have similar attenuation to the device that the message is being transmitted to. In this case the two devices can mutually interfere and prevent the message from being passed on because their re-transmitted messages are not carefully synchronized. This is where the ability to change pattern seeds becomes important. By choosing a different pattern seed new re-transmission patterns will be formed. The likelihood that the new patterns will have the two interfering devices repeatedly re-transmitting at the same time, when the new patterns are generated by different pattern seeds, can be made small with a sufficient number of pattern seeds. When the devices are not transmitting at the same time they will not mutually interfere and the message will be passed on to the device the message is being transmitted to. In this way the central controller can try numerous alternative re-transmit patterns for reliability, while no single device is required for reliable messaging. Importantly, these messages also incorporate the set-ID into their error check. The multiple repeats of messages increase the odds that inter-set miscommunication could occur and hence the importance of rejecting this miscommunication is increased. Again the incorporation of the set-ID into the error check reduces the message size.

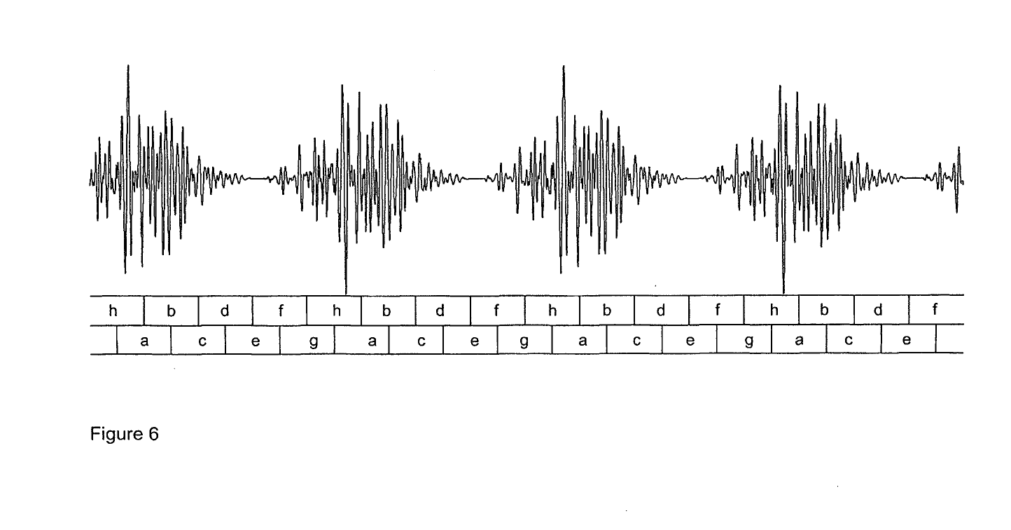

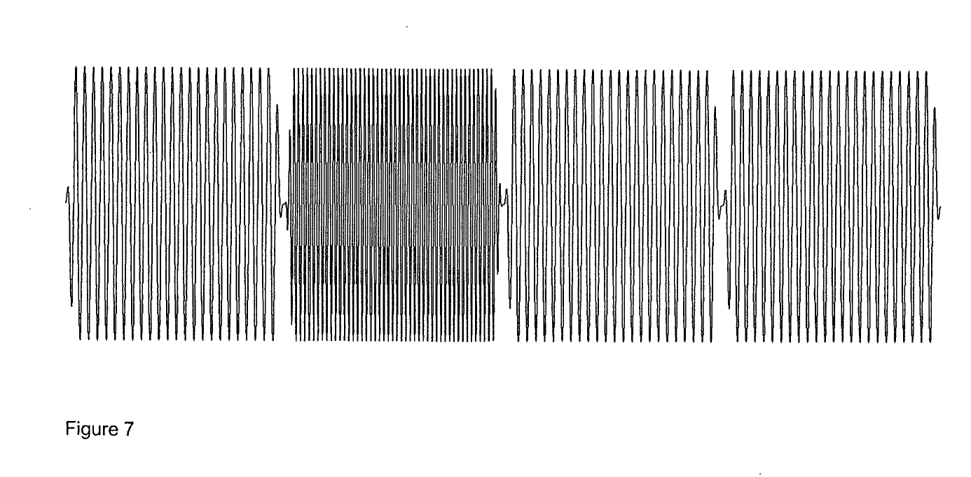

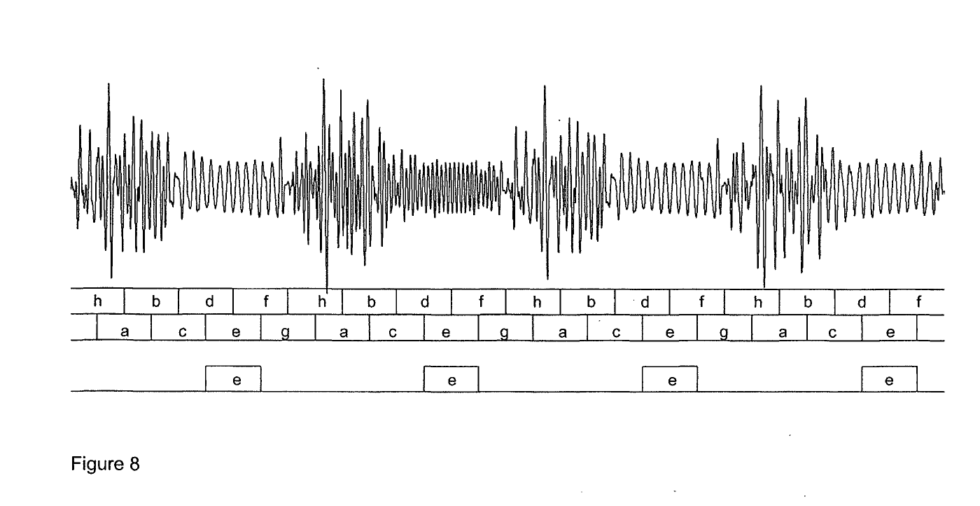

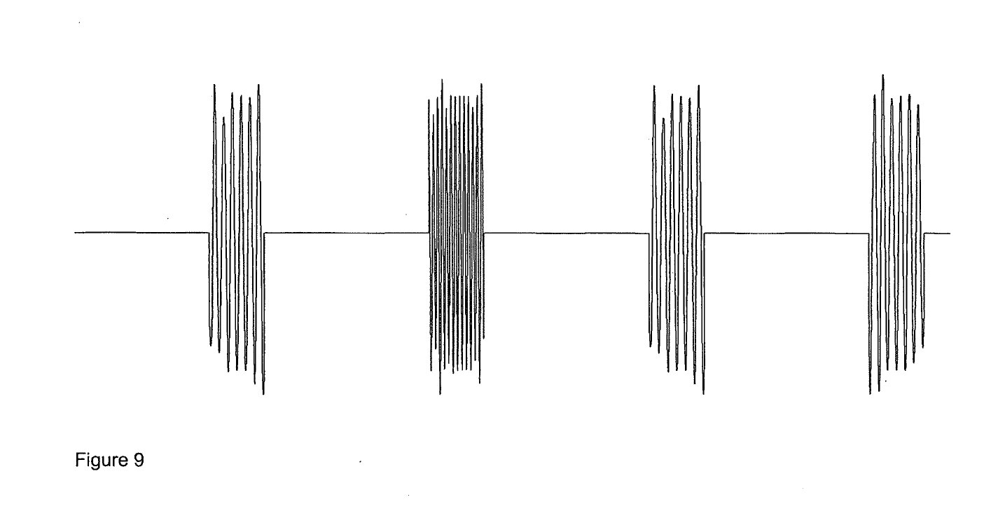

In some situations noise occurs in a cyclical manner. An example is the noise on the AC power line where device noise tends to repetitively and cyclically occur during the same period of the cyclical AC voltage. FIG. 5 shows AC power line voltage with noise. As can be seen, the noise appears at the same locations on the AC voltage repetitively and of substantially the same form. FIG. 5 shows noise similar to that produced by halogen light power supplies. FIG. 6 shows the same noise with the AC voltage filtered out. It should be noted that in this case the noise inverts every half cycle of the AC voltage. This inversion does change the spectral content of the noise in general but merely affects the phase of the noise. FIG. 6 also shows a number of reception channels that are used to try and receive a transmitted message. They indicated by the letters “a” through “h” although more or fewer channels could be used. It should be noted that these channels combine to span the entire length of the cycle of the noise. FIG. 7 shows a portion of transmitted message without noise. FIG. 7 shows four bits of a message, or for one skilled in the art, four symbols of the message. FIG. 8 shows this portion with the noise added as it would appear at the receiving device as well as the reception channels the receiving device is using.

As can be seen in FIG. 8, channel “e” which is also shown as a separate channel at the bottom of FIG. 8 has the least amount of noise on it. FIG. 9 shows the this portion of the message with noise only during the span of channel “e”. As can be seen, comparing this figure to FIG. 7, the message symbols are not obscured by noise.

By transmitting the message to be received so that its symbols effectively span the entire length of the cycle of noise and by having multiple receiving channels that combine to effectively span the entire length of the cycle of noise, at least one of the receiving channels will repetitively have the message symbols and the best case noise appear during its span. The channel must be sufficiently long in duration to capture the information content of the symbol being transmitted.

As can be seen, the message symbols and the cycle of noise need not be synchronized, nor do the reception channels and the noise need to be synchronized, nor do the message symbols and the reception channels need to be synchronized. They need only be of, or combine to form in the case of the reception channels, substantially the same duration.

Here again there are multiple times where inter-set miscommunication may occur. The noise shown could be a message from another set of devices and where the noise dominates the other message could dominate and inter-set miscommunication could occur. In particular, referring back to the hijacking of messages, the multiple channels allow a message from another set of devices to dominate an in-set message without the need for the message from the other set of devices to be well synchronized with the in-set message. Incorporating the set-ID into the error check is effective at eliminating this inter-set miscommunication and also allows the messages to have a longer error check and still be of the same size or shorter. In the example above there are 8 channels that could potentially pass a bad message by having the error check fail. Adding bits, for example 4 bits, to the error check can reduce this by making the odds of it failing smaller.

Much of the above discussion uses the power line and building wiring as an example. However, it should be understood that these are examples only and do not imply that the techniques described above are only useful for power line communication.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for preventing inter-set miscommunication while maintaining robust signalling in a noisy environment, the apparatus comprising:
a controller and a set of devices having a unique set ID and communicating with said controller, and wherein said set of devices communicates with said controller by transmitting and receiving messages to and from said controller respectively via an electrically noisy transmission medium, and wherein said messages include: (a) inquiries from said controller to said set of devices inquiring as to whether each device in said set of devices doesn't need attention or does need attention from said controller, (b) responses to said controller from said each device as to whether said each device said doesn't need attention or said does need attention of said controller,
and wherein said each device has a unique device ID which is unique within said set of devices,
and wherein said devices each include a transmitter/receiver, and include a processor, and associated memory cooperating with said transmitter/receiver, to transmit and receive said messages,
and wherein said each device transmits its own said responses and repeatedly receives said responses of other devices of said devices and reflects said responses of said other devices in a look-back record in said message and transmit said message,
wherein each said message consists of: a preamble segment, a doesn't need attention or does need attention segment and an error check segment wherein said attention segment contains said doesn't-need-attention or does-need-attention of said controller for said each device and for those of said devices said transmitting before said each device and received by said each device, and wherein said device ID has been incorporated into said error check segment, and wherein said each device is adapted to, using said set ID, make said error check segment set ID dependant.

2. The apparatus of claim 1 wherein said attention segment contains said needs-attention or said doesn't-need attention of said controller for said each device and for a sequentially previously transmitted series of said responses of said other devices which have sequentially previously transmitted immediately before transmission of said response by said each device, wherein said series is limited in length by a length of said attention segment.

3. The apparatus of claim 2 wherein said controller is adapted to listen for said each device during an associated series of time-slots and thereby determines a device ID of an incoming said response by matching a corresponding time-slot of said time-slots with a corresponding expected said device ID, and wherein said controller adds said expected said device ID to said attention segment and compares a resulting segment with said error check segment,
and wherein said controller is adapted to extract from said attention segment said needs-attention or doesn't-need attention of all corresponding said devices and to transmit a further query to those said devices identified as having a do-need-attention status.

4. The apparatus of claim 3 wherein said look back record is a bit string indicating, for a corresponding each said device in said record, a binary don't need/need attention record.

5. The apparatus of claim 1 wherein said set has a set ID associated therewith which includes said unique identifying number of said controller, and wherein each said device has a device ID unique to said set which is shorter than a corresponding unique identifying number of each said device, and wherein each said message includes a preamble at a leading end of said each message and error check segment at a trailing end of said each message, and wherein said error check segment includes corresponding said device ID therein, and wherein said corresponding device ID and said system ID are not included in said each message elsewhere other, and wherein said controller and said devices are adapted to use an error check procedure using said error check segment which is thereby dependent on said set ID.

6. The apparatus of claim 1 wherein each said message is transmitted using a seed to generate a seed-specific error check procedure which generates a specific said error check.

7. The apparatus of claim 1 wherein each said message contains a pattern seed.

8. The apparatus of claim 7 wherein each said message further comprises corresponding pattern length information and a corresponding pattern count incrementing for a transmission window, wherein said length information dictates a corresponding length of a corresponding pattern.

9. The apparatus of claim 1 wherein said medium is an alternating current power line and therefore said noise is cyclical and wherein each said controller and said devices are adapted to: (a) provide an array of reception channels collectively spanning a length of one cycle of an alternating current waveform in said alternating current power line and corresponding said cyclical noise; and (b) receiving said message within a less noisy segment using a corresponding channel,
wherein what each said channel receives is treated as a potential said message and checked by said error check segment in an error check.

10. An apparatus for preventing inter-set miscommunication while maintaining robust signalling in a noisy environment, the apparatus comprising:
a controller and a set of devices having a unique set ID and communicating with said controller, and wherein said set of devices communicates with said controller by transmitting and receiving messages to and from said controller respectively via an electrically noisy transmission medium, and wherein said messages include: (a) inquiries from said controller to said set of devices inquiring as to whether each device in said set of devices doesn't need attention or does need attention from said controller, (b) responses to said controller from said each device as to whether said each device said need attention or said doesn't need attention of said controller,
and wherein said each device has a unique device ID which is unique within said set of devices,
and wherein said devices each include a transmitter/receiver, and include a processor, and associated memory cooperating with said transmitter/receiver, to transmit and receive said messages,
wherein each said message consists of: a preamble segment, a doesn't need attention or does need attention segment and an error check segment wherein said attention segment contains said doesn't need attention or does need attention of said controller for said each device and wherein said device ID has been incorporated into said error check segment, and wherein said each device is adapted to, using said set ID, to make said error check segment set ID dependant.

11. The apparatus of claim 10 wherein said controller is adapted to listen for said each device during an associated series of time-slots and thereby determines a device ID of an incoming said response by matching a corresponding time-slot of said time-slots with a corresponding expected said device ID, and wherein said controller adds said expected said device address to said attention segment and adds said set address to said attention segment and compares a resulting segment with said error check segment,
and wherein said controller is adapted to extract from said attention segment said needs attention or doesn't need attention of said device and to transmit a further query to said device identified as having a do-need-attention status.

12. The apparatus of claim 10 wherein said set has a set ID associated therewith which includes said unique identifying number of said controller, and wherein each said device has a device ID unique to said set which is shorter than a corresponding unique identifying number of each said device, and wherein each said message includes a preamble at a leading end of said each message and error check segment at a trailing end of said each message, and wherein said error check segment includes corresponding said device ID therein, and wherein said corresponding device ID and said system ID are not included in said each message elsewhere, and wherein said controller and said devices are adapted to use an error check procedure using said error check segment which is dependent on said set ID.

13. The apparatus of claim 10 wherein each said message is transmitted using a seed to generate a seed-specific error check procedure which generates a specific said error check.

14. The apparatus of claim 10 wherein each said message contains a pattern seed.

15. The apparatus of claim 14 wherein each said message further comprises corresponding pattern length information and a corresponding pattern count incrementing for a transmission window, wherein said length information dictates a corresponding length of a corresponding pattern.

16. The apparatus of claim 10 wherein said medium is an alternating current power line and therefore said noise is cyclical and wherein each said controller and said devices are adapted to: (a) provide an array of reception channels collectively spanning a length of one cycle of an alternating current waveform in said alternating current power line and corresponding said cyclical noise; and (b) receiving said message within a less noisy segment using a corresponding channel,
wherein what each said channel receives is treated as a potential said message and checked by said error check segment in an error check.

17. An apparatus for preventing inter-set miscommunication while maintaining robust signalling in a noisy environment, the apparatus comprising:
a controller and a set of devices having a unique set ID and communicating with said controller, and wherein said set of devices communicates with said controller by transmitting and receiving messages to and from said controller respectively via an electrically noisy transmission medium, and wherein said messages include: (a) inquiries from said controller to said set of devices inquiring as to whether each device in said set of devices doesn't need attention or does need attention from said controller, (b) responses to said controller from said each device as to whether said each device said need attention or said doesn't need attention of said controller,
and wherein said each device has a unique device ID which is unique within said set of devices,
and wherein said devices each include a transmitter/receiver, and include a processor, and associated memory cooperating with said transmitter/receiver, to transmit and receive said messages,
wherein each said message consists of: a preamble segment, a doesn't need attention or does need attention segment and an error check segment wherein said attention segment contains said doesn't need attention or does need attention of said controller for said each device, and wherein said device ID has been incorporated into said error check segment, and wherein said each device is adapted to, using said set ID, to make said error check segment set ID dependant,
wherein each said message contains a pattern seed.

18. The apparatus of claim 17 wherein each said message further comprises corresponding pattern length information and a corresponding pattern count incrementing for a transmission window, wherein said length information dictates a corresponding length of a corresponding pattern.

19. The apparatus of claim 18 wherein said medium is an alternating current power line and therefore said noise is cyclical and wherein each said controller and said devices are adapted to: (a) provide an array of reception channels collectively spanning a length of one cycle of an alternating current waveform in said alternating current power line and corresponding said cyclical noise; and (b) receiving said message within a less noisy segment using a corresponding channel,
wherein what each said channel receives is treated as a potential said message and checked by said error check segment in an error check.

20. A method for preventing inter-set miscommunication while maintaining robust signalling in a noisy environment comprising the steps of:
a) providing a set of devices, each device of said set of devices having a receiver and transmitter cooperating with a processor and memory in said each device,
b) providing a controller with a corresponding receiver and transmitter cooperating with a corresponding controller processor and controller memory in said controller,
c) transmitting a first message to said each device from said controller asking said each device if said each device needs attention from said controller or does not need attention from said controller,
d) said each device transmitting in response a don't-need-attention/need attention message corresponding to whether said each device needs the attention or not of said controller,
e) said each device maintaining a look-back record of said response of any of said each devices previously said transmitting a corresponding said response corresponding to said first message,
f) said each device composing said response including said look-back record and transmitting said response to said controller wherein said controller records said responses from said each device according to a said response received directly from said each device and said response for a particular said device from said look-back record from any said response from any of said each devices,
g) wherein each said responses are messages which consist of a preamble, a don't-need-attention/need-attention for a corresponding said device, said look-back record, and an error check, and wherein said device ID has been incorporated into each said error check for a corresponding said device, unique within said set, and, using a set ID for said set, making said error check dependant on said set ID,
h) and wherein said controller upon receiving said each message within an allotted time-slot for a particular device of said devices, adds a corresponding said device ID and to said don't-need attention/need attention and said look-back record and performs an error check comparing said error check against said don't-need attention/need attention and said look-back record having added said device ID,
whereby said error check is made set ID dependant.
